(19) United States
(12) Patent Application Publication
(10) Pub. No.: US 2006/0070027 A1
(43) Pub. Date: Mar. 30, 2006

(54) Enhancing exception information in virtual machines

(76) Inventor: Ralf Schmelter, Wiesloch (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/949,042

(22) Filed: Sep. 24, 2004

(51) Int. Cl. G06F 9/44

(52) U.S. Cl. 717/114

(57) ABSTRACT

Methods and apparatus, including computer systems and program products to provide a Java virtual machine (VM) a extraction mechanism, which enables the Java VM to store a root set of information, which will also be referred to as exception data, in exception objects. The exception handler that catches the exception object can then call an extraction method to read the exception data from the exception object, extract additional information from the call stack using the exception data, and dump the exception data and extracted information into a file where it can be inspected later. The information dumped into the file can be used to facilitate development and debugging of Java-based software. Unlike other types of trace mechanisms utilized in Java systems, e.g., which may dump the entire core, the extraction mechanism enables a limited amount of information relating to specific exceptions to be stored for later inspection.

### BACKGROUND

The present application relates to digital data processing, and more particularly to exception handling and debugging in virtual machines.

A runtime system is a code execution environment that executes instructions or code in user requests and that provides runtime services for that code. Core runtime services can include functionality such as process, thread, and memory management (e.g., laying out objects in the server memory, sharing objects, managing references to objects, and garbage collecting objects).

One example of a runtime system is a virtual machine (VM). A VM is an abstract machine that can include an instruction set, a set of registers, a stack, a heap, and a method area, like a real machine or processor. A VM essentially acts as an interface between program code and the actual processor or hardware platform on which the program code is to be executed. The program code includes instructions from the VM instruction set that manipulates the resources of the VM. The VM executes instructions on the processor or hardware platform on which the VM is running, and manipulates the resources of that processor or hardware platform, so as to effect the instructions of the program code. In this way, the same program code can be executed on multiple processors or hardware platforms without having to be rewritten or recompiled for each processor or hardware platform. Instead, a VM is implemented for each processor or hardware platform, and the same program code can be executed in each VM. The implementation of a VM can be in code that is recognized by the processor or hardware platform.

The Java programming language is designed to be implemented on a Java VM. A Java source program is compiled into program code known as bytecode. Bytecode can be executed on a Java VM running on any processor or platform. The Java VM can either interpret the bytecode one instruction at a time, or the bytecode can be further compiled for the real processor or platform using a just-in-time (JIT) compiler.

Java uses exceptions for error and exception handling. An exception is an event that disrupts the normal flow of instructions during the execution of a program. When an error occurs in a Java program, an exception object is created and handed to the VM. The act of creating and handing off an exception object is referred to as “throwing” an exception. The VM searches the call stack for a method that can “catch” the exception, i.e., a method that contains an exception handler appropriate for handling that particular type of exception.

The Java VM can directly throw an exception in response to detecting an error, e.g., due to an arithmetic exception, such as dividing by zero, or indexing exceptions, which may be caused by trying to access an array element with an index outside of the array bounds. Exceptions can also be thrown by Java code using the throw statement. These “program” exceptions can include additional information provided by the programmer from data that is accessible at the point where the exception is thrown that can be used to identify the source of the problem that caused the exception. However, exceptions thrown by the Java VM cannot be enhanced in this manner. This can lead to situations in which there is not enough information stored in the exception object to enable a developer to track down the problem that caused the exception. This is especially a problem in enterprise systems, where many Java applications can run concurrently on the same VM.

### SUMMARY

The present invention provides methods and apparatus, including computer program products, that implement techniques for storing trace information for certain exceptions generated in a VM.

In one general aspect, the techniques are implemented as methods or apparatus performing operations. The operations include running an application program in an runtime system and creating an exception object when an exception condition occurs during the running of the application. A root set of data is collected in the runtime system without action of the application program and stored in the exception object. The root set data can be collected by inspecting methods in the call stack, including methods below a topmost method, and collecting root set data from the inspected methods. When the exception is caught, trace data including the root set data is dumped to a file.

The data constituting root set data can be defined by an exception configuration input, which can define root set data according to the exception object class. The exception configuration can define different configurations for different exception object classes. Also, the runtime system can receive exception configuration input to change the exception configuration at any time during the running of the application program.

The root set data can include local variables and parameters of methods in methods in the call stack of the application program at the occurrence of the exception condition, data in the static fields of classes corresponding to the methods in the stack, data in a constant pool, and references to an objects. The runtime system can traverse objects referenced in the root set data to a specified depth and extract information from the traversed objects. The extracted information can be included in the trace information dumped to the file.

The techniques described in this specification can be implemented to realize one or more of the following advantages. The techniques can be used to store information for certain exceptions that can be examined later for debugging and development purposes. Also, a developer can throw exceptions that trigger the technique at certain points in a program to provide trace information providing information as to the state virtual machine at different times during execution of the program.

Other features and advantages of the invention will become apparent from the following description and from the claims.

### BRIEF DESCRIPTION OF THE DRAWINGS

FIG. 1 is a flowchart describing creating and throwing an exception object in an exception handling and data collection operation according to an implementation.

FIG. 2 is a flowchart describing catching an exception object and extracting information in the exception handling and data collection operation.

Like reference numbers and designations in the various drawings indicate like elements.

### DETAILED DESCRIPTION

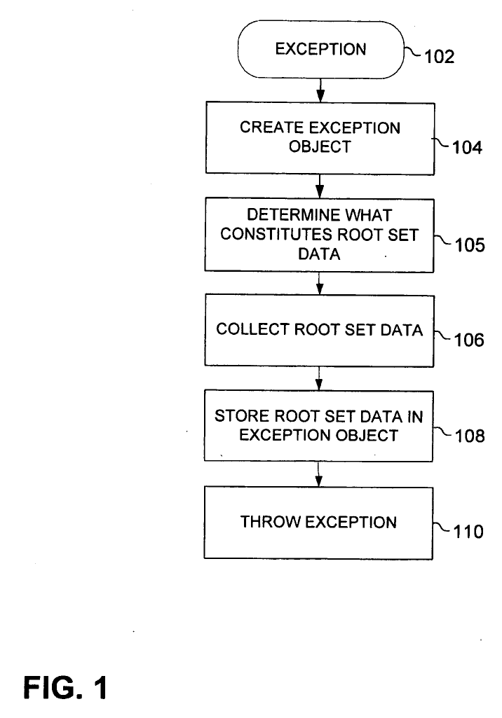

As shown in FIG. 1, a Java VM implemented in accordance with the invention stores a root set of information, which will also be referred to as exception data, in exception objects. The exception handler that catches the exception object can then call an extraction method to read the exception data from the exception object, extract additional information from the call stack using the exception data, and dump the exception data and extracted information into a file where it can be inspected later, e.g., to facilitate development and debugging of Java-based software. Unlike other types of trace mechanisms utilized in Java systems, e.g., which may dump the entire core, the extraction mechanism enables a limited amount of information relating to specific exceptions to be stored for later inspection.

FIG. 1 is a process flowchart describing creating and throwing an exception object in exception handling and data collection process according to an implementation. When an exception occurs (102), the VM creates an exception object appropriate for the exception (104). The VM inspects the methods in the call stack, including those below the topmost method, and collects a root set of data from the inspected methods. The amount of data the VM stores in the exception object can be configurable. For example, in an implementation, possible configurations for data to store in the exception object include the following: nothing; only primitive parameters; all parameters (references and primitive types); only primitive local variables and parameters; or all local variables and parameters. Additionally, different configurations can be used for different methods on the call stack. For example, the N topmost methods (where N is configurable) can have a different configuration than the other methods in the call stack. Also, because a method may access static fields of other classes, the VM can also be configured to collect the static fields of all classes contained in the constant pool for methods in the call stack.

Some classes of exceptions can be more interesting for debugging purposes than others. For example, exceptions are not always thrown due to errors. During class loading, much of the communication between related class loaders is done through exceptions. This type of exception may not be relevant to development and debugging endeavors. Also, a large number of exceptions are typically thrown during execution of a program. To store trace information for all such exceptions may consume undue computational resources. To conserve computer time and resources, the amount of data in the root set to be stored in the different classes of exception objects can be configured by a programmer based on which exceptions are of interest. Also, in an implementation, the VM can dynamically change the configurations for different classes during runtime execution of the program. This can be useful since the importance or frequency of certain exceptions can change at different points during the execution of a program.

The VM determines what constitutes root set data based on the configuration (105) and collects the root set data (106). The VM then stores the root set data in the exception object (108). Primitive values (integral and floating point types) are stored directly. For variables and parameters holding references to objects, only the references are stored, which prevents the referenced objects from being collected as garbage. The VM then throws the exception object containing the additional information (110).

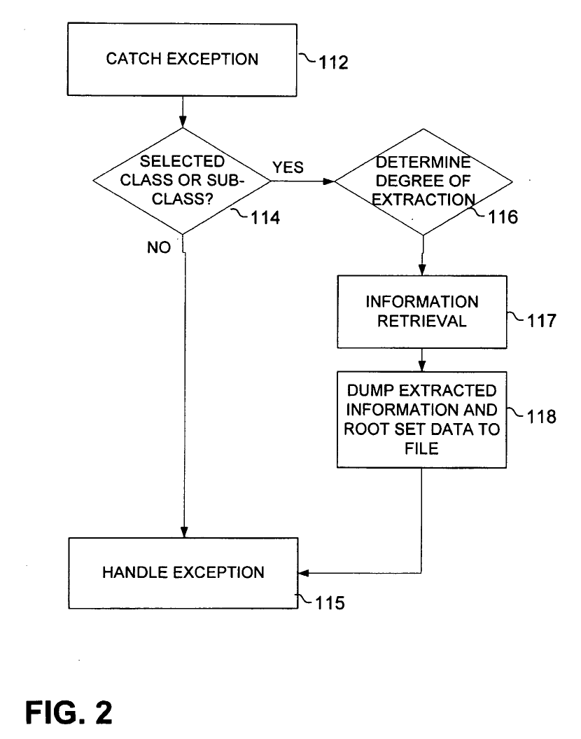

FIG. 2 is a flowchart describing catching an exception object and extracting information in the exception handling and data collection operation. The extraction mechanism can be associated with one or more selected exception classes. The selected classes can be selected from the hierarchy of classes for exception objects, which are all rooted at class Throwable. When the exception object is caught (112) by the appropriate handler, the VM identifies the class of the exception object (114). If the exception object is not an instance of a selected class, or subclass of the selected class, the exception will simply be handled (115). The handled exception object can then be deleted, freeing resources. However, if the exception object is an instance of a selected class or subclass, the exception handler that catches the exception object calls an extraction method to retrieve additional information based on the references. The amount of information extracted depends on the amount of data stored in the exception object. The amount of information extracted also depends on values in the catch block defining a maximum traversion depth of references and a maximum number of array components to be extracted. The degree of extraction is determined based on these maximum values (116). Object references are recursively traversed (up to the maximum depth) during information retrieval and the field of the visited objects are stored (117). The extracted information and root set of data is then dumped to a trace file (118). The dumped information can then later be viewed with a graphical toolkit, e.g., one similar to a debugger, where the values of the local variables, fields and parameters can be examined.

The extraction mechanism can be implemented in a “green” threaded Java VM to minimizes the chance of other threads modifying the referenced objects after the exception is created. Green threads are user-level threads that are scheduled by a runtime system rather than a native operating system (OS). Because a green thread is not a native OS thread, a green thread cannot be seen from the point of view of the native OS and can only be seen from the point of the VM, and hence cannot be preempted by the OS scheduler.

The extraction mechanism can be invoked purposefully to aid in software development. In particular, a developer can intentionally trigger exceptions meeting the extraction criteria at specific points in the program to save the state of the program at those points, thereby creating snapshots of the VM at certain stages of operation.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments, but other embodiments can be implemented and are within the scope of the following claims. For example, the operations of the invention can be performed in a different order and still achieve desirable results. As one example, the processes depicted in FIGS. 1 and 2 do not require the particular order shown, or sequential order, to achieve desirable results (e.g., the local and shared garbage collection operations can be performed at different places within the overall process). In certain implementations, multitasking and parallel processing may be preferable. Other embodiments are within the scope of the following claims.

1-22. (canceled)

23. A method, comprising:
creating an exception object upon occurrence of an exception condition during running of an application program, the exception object being an instance of an exception object class;
selectively collecting exception information in runtime; and
storing the exception information in the exception object.

24. The method of claim 23, wherein the selectively collecting of the exception information comprises determining the exception information based on exception configuration.

25. The method of claim 24, further comprising receiving the exception configuration defining information constituting the exception information.

26. The method of claim 24, wherein the exception configuration comprises one or more of manually entered exception configuration and dynamically changing exception configuration for different classes during runtime.

27. The method of claim 23, wherein the exception information comprises one or more of data in static fields of classes corresponding to methods in a call stack, data in a constant pool, and data relating to a reference to the exception object.

28. The method of claim 23, further comprising:
catching the exception object;
selectively retrieving trace data from the exception information at the exception object; and
dumping the trace data into a trace file.

29. The method of claim 28, wherein the catching of the exception object further comprises:
traversing objects referenced in the exception information to a specified depth;
extracting trace information from the traversed objects; and
providing the trace information as the trace data to be dumped into the trace file.

30. The method of claim 23, wherein the selectively collecting of the exception information further comprises:
inspecting the methods in the call stack, including methods below a topmost method; and
selectively collecting the exception information from the inspected methods.

31. A system, comprising:
a virtual machine interfacing between a program code and a processor where the program code is executed, the virtual machine to:
create an exception object upon occurrence of an exception condition during running of an application program, the exception object being an instance of an exception object class;
selectively collect exception information in runtime; and
store the exception information in the exception object.

32. The system of claim 31, wherein the selectively collecting of the exception information comprises determining the exception information based on exception configuration.

33. The system of claim 32, further comprising receiving the exception configuration defining information constituting the exception information.

34. The system of claim 31, wherein the exception information comprises one or more of data in static fields of classes corresponding to methods in a call stack, data in a constant pool, and data relating to a reference to the exception object.

35. The system of claim 31, further comprising an extraction mechanism associated with the classes as identified by the virtual machine, the extraction mechanism to:
catch the exception object;
selectively retrieve trace data from the exception information at the exception object; and
dump the trace data into a trace file.

36. The system of claim 35, wherein the extraction mechanism is further to:
traverse objects referenced in the exception information to a specified depth;
extract trace information from the traversed objects; and
provide the trace information as the trace data to be dumped into the trace file.

37. The system of claim 31, wherein the virtual machine is further to:
inspect the methods in the call stack, including methods below a topmost method; and
selectively collect the exception information from the inspected methods

38. A machine-readable medium having stored thereon instructions which, when executed by a machine, cause the machine to:
create an exception object upon occurrence of an exception condition during running of an application program, the exception object being an instance of an exception object class;
selectively collect exception information in runtime; and
store the exception information in the exception object.

39. The machine-readable medium of claim 38, wherein the exception information comprises one or more of data in static fields of classes corresponding to methods in a call stack, data in a constant pool, and data relating to a reference to the exception object.

40. The machine-readable medium of claim 38, wherein the instructions which, when executed by the machine, further caused the machine to:
catch the exception object;
selectively retrieve trace data from the exception information at the exception object; and
dump the trace data into a trace file.

41. The machine-readable medium of claim 40, wherein the catching of the exception object further comprises:
traversing objects referenced in the exception information to a specified depth;
extracting trace information from the traversed objects; and
providing the trace information as the trace data to be dumped into the trace file.

42. The machine-readable medium of claim 38, wherein the selectively collecting of the exception information further comprises:
inspecting the methods in the call stack, including methods below a topmost method; and
selectively collecting the exception information from the inspected methods.
